(19) United States
(12) Patent Application Publication
(10) Pub. No.: US 2025/0200021 A1
(43) Pub. Date: Jun. 19, 2025

(54) DATA GENERATION METHOD, MEDIUM, AND ELECTRONIC DEVICE

(71) Applicant: Douyin Vision Co., Ltd., Beijing (CN)

(72) Inventors: Qing LIU, Beijing (CN); Shuisheng ZHANG, Beijing (CN); Danchi FAN, Beijing (CN); Yuan ZHANG, Beijing (CN)

(21) Appl. No.: 18/981,239

(22) Filed: Dec. 13, 2024

(30) Foreign Application Priority Data
Dec. 15, 2023 (CN) 202311735702.X

(51) Int. Cl. G06F 16/22

(52) U.S. Cl. CPC G06F 16/2282

(57) ABSTRACT

A data generation method and apparatus, a medium, and an electronic device are provided. The method includes: displaying a data generation page of a data table; in response to a configuration operation for a configuration item of the data table in the data generation page, displaying configuration information corresponding to the configuration item; in response to a trigger operation for a generation control in the data generation page, generating metadata of the data table based on a constraint condition, in which the constraint condition comprises the configuration information and user information corresponding to a user who performs the configuration operation; and displaying the metadata in a display region for displaying the metadata in the data generation page.

### CROSS-REFERENCE TO RELATED APPLICATION

This application claims the priority of Chinese Patent Application No. 202311735702.X filed on Dec. 15, 2023, the disclosure of which is incorporated by reference herein in its entirety as part of the present application.

### TECHNICAL FIELD

The present disclosure relates to big data technologies. Specifically, the present disclosure relates to a data generation method and apparatus, a medium, and an electronic device.

### BACKGROUND

In the field of data management of big data, metadata, as an important part of data assets, plays an important role in data search and data analysis based on data in a data table.

Therefore, the accuracy of the metadata has an important impact on the quality and efficiency of data management.

### SUMMARY

This Summary is provided to introduce concepts in a simplified form, the concepts are further described below in the Detailed Description. This Summary is not intended to identify key features or essential features of the claimed subject matter, nor is it intended to limit the scope of the claimed subject matter.

According to a first aspect, the present disclosure provides a data generation method, which comprises:
displaying a data generation page of a data table;
in response to a configuration operation for a configuration item of the data table in the data generation page, displaying configuration information corresponding to the configuration item;
in response to a trigger operation for a generation control in the data generation page, generating metadata of the data table based on a constraint condition, in which the constraint condition comprises the configuration information and user information corresponding to a user who performs the configuration operation; and
displaying the metadata in a display region for displaying the metadata in the data generation page.

According to a second aspect, the present disclosure provides a data generation apparatus, which comprises:
a first display module, configured to display a data generation page of a data table;
a second display module, configured to, in response to a configuration operation for a configuration item of the data table in the data generation page, display configuration information corresponding to the configuration item;
a generation module, configured to, in response to a trigger operation for a generation control in the data generation page, generate metadata of the data table based on a constraint condition, in which the constraint condition comprises the configuration information and user information corresponding to a user who performs the configuration operation; and
a third display module, configured to display the metadata in a display region for displaying the metadata in the data generation page.

According to a third aspect, the present disclosure provides a computer-readable medium having a computer program stored thereon, when the program is executed by a processing apparatus, the steps of the method according to the first aspect are implemented.

According to a fourth aspect, the present disclosure provides an electronic device, which comprises:
a storage apparatus having a computer program stored thereon; and
a processing apparatus configured to execute the computer program in the storage apparatus, to implement the steps of the method according to any one of the first aspect.

Other features and advantages of the present disclosure will be described in detail in the following Detailed Description.

### BRIEF DESCRIPTION OF DRAWINGS

The above and other features, advantages, and aspects of the embodiments of the present disclosure become more apparent with reference to the following specific embodiments and in conjunction with the accompanying drawings. Throughout the drawings, the same or similar reference numerals denote the same or similar elements. It should be understood that the drawings are schematic and components and elements are not necessarily drawn to scale. In the drawings:

FIG. 1 is a flowchart of a data generation method according to an exemplary embodiment of the present disclosure.

FIG. 2 is a schematic diagram of a data generation page according to an exemplary embodiment of the present disclosure.

FIG. 3 is another schematic diagram of a data generation page according to an exemplary embodiment of the present disclosure.

FIG. 4 is another schematic diagram of a data generation page according to an exemplary embodiment of the present disclosure.

FIG. 5 is another schematic diagram of a data generation page according to an exemplary embodiment of the present disclosure.

FIG. 6 is another schematic diagram of a data generation page according to an exemplary embodiment of the present disclosure.

FIG. 7 is a block diagram of a data generation module according to an exemplary embodiment of the present disclosure.

FIG. 8 is a structural schematic diagram of an electronic device according to an exemplary embodiment of the present disclosure.

### DETAILED DESCRIPTION

Embodiments of the present disclosure will be described in detail below with reference to the accompanying drawings. Although some embodiments of the present disclosure are shown in the drawings, it should be understood that the present disclosure may be implemented in various forms and should not be construed as being limited to the embodiments described herein. Rather, these embodiments are provided for a more thorough and complete understanding of the present disclosure. It should be understood that the accompanying drawings and the embodiments of the present disclosure are only for exemplary purposes, and are not intended to limit the protection scope of the present disclosure.

It should be understood that various steps described in the method implementations of the present disclosure may be performed in different orders, and/or performed in parallel. In addition, additional steps may be included and/or one or more illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or the interdependence relationship of these apparatuses, modules, or units.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the technical solution disclosed in each embodiment of the present disclosure is used, the user should be informed of the type, use scope, use scenario, and the like of the personal information involved in the present disclosure in an appropriate manner in accordance with relevant laws and regulations, and the user's authorization should be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation of the technical solution of the present disclosure based on the prompt information.

As an optional but non-limiting implementation, in response to receiving the user's active request, for example, the prompt information may be sent to the user in a pop-up window, and the prompt information may be presented in the pop-up window in text. In addition, the pop-up window may also carry a selection control for the user to select “agree” or “disagree” to provide personal information to the electronic device.

It can be understood that the above notification and user authorization obtaining process are only illustrative and do not limit the implementations of the present disclosure. Other methods that comply with relevant laws and regulations may also be applied to the implementations of the present disclosure.

In addition, it can be understood that the data involved in this technical solution (including but not limited to the data itself, the acquisition or use of data) should comply with the requirements of corresponding laws and regulations and related regulations.

In the field of big data management, especially in terms of metadata management of data assets, the generation of metadata is usually implemented in the following two ways. The first way is a manual entry way. The user manually fills in the metadata through a form or a text box. Although this way can ensure that the user has full control over the metadata, there are also some obvious defects. For example, the efficiency is low, it is prone to errors, and it is difficult to achieve consistency and standardization of the metadata for different users, thereby reducing the accuracy of the metadata. The second way is a rule-based automatic filling way. Metadata is extracted from the name or content of the data table based on the preset rules and keywords, and is automatically filled into the corresponding fields. Although this way can improve the operation efficiency of the user and reduce the input errors of the user, there are also some obvious defects. For example, the user needs to spend a lot of manpower and time to formulate and maintain rules and keywords suitable for different data tables, especially when the business requirements and data sources are constantly changing, the user needs to continuously update and optimize the rules and keywords. The user cannot ensure that the preset rules and keywords can cover all data tables or can fully meet the expectations of users. There may be problems such as incomplete, inaccurate, and inconsistent generated metadata, resulting in low satisfaction of the users with the generation result. In addition, when the user uses the rule-based automatic filling way, the user cannot obtain the user's feedback on the generated metadata in time, and cannot adjust and optimize the generated metadata information according to the user's feedback or business changes, resulting in low adaptability.

In view of this, the embodiments of the present disclosure provide a data generation method and apparatus, a medium, and an electronic device, which can implement personalized requirements of the user for the metadata without the need for the user to add the metadata manually, and the user information is considered when the metadata is generated, thereby improving the accuracy of the metadata, which is beneficial to improving the quality and efficiency of data management.

The embodiments of the present disclosure are further explained and described below with reference to the accompanying drawings.

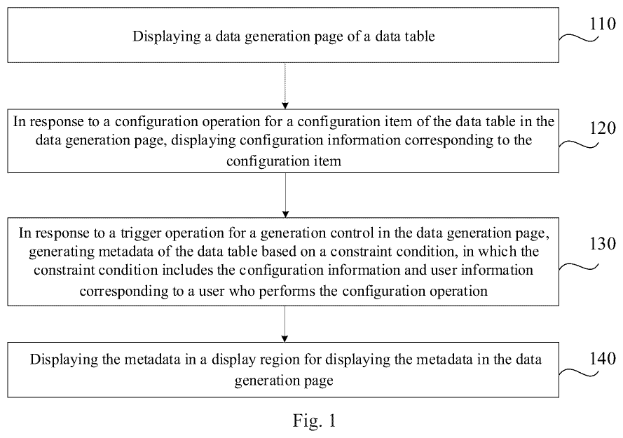

FIG. 1 is a flowchart of a data generation method according to an exemplary embodiment of the present disclosure. As shown in FIG. 1, at least one embodiment of the present disclosure provides a data generation method, which may be performed by an electronic device, specifically, may be performed by a data generation apparatus, which may be implemented by software and/or hardware, and the software and/or hardware is configured in the electronic device. As shown in FIG. 1, the data generation method may include the following steps.

Step 110: displaying a data generation page of a data table.

Step 120: in response to a configuration operation for a configuration item of the data table in the data generation page, displaying configuration information corresponding to the configuration item.

Step 130: in response to a trigger operation for a generation control in the data generation page, generating metadata of the data table based on a constraint condition, in which the constraint condition includes the configuration information and user information corresponding to a user who performs the configuration operation.

Step 140: displaying the metadata in a display region for displaying the metadata in the data generation page.

The metadata is the information describing data, and the metadata may include a name of the data, a type of the data, a format of the data, a source of the data, a description for describing the data table, and information for describing each field in the data table, and the like. In this embodiment, the metadata and the configuration information corresponding to the configuration item may be data for describing different data.

As an example, the data table may be a Hive table.

The configuration item for the data table in the data generation page may include a necessary configuration item and a non-necessary configuration item, and the user may only need to perform the configuration operation for the necessary configuration item. That is, in a possible way, the above step 120 and step 130 may be implemented in the following way: in response to a configuration operation for the necessary configuration item of the data table in the data generation page, displaying configuration information corresponding to the necessary configuration item; and in response to a trigger operation for a generation control in the data generation page, generating metadata of the data table based on the configuration information and the user information corresponding to the user who performs the configuration operation.

For example, the configuration operation may be a selection operation, an input operation, and the like. For example, when the configuration item is used to select a database corresponding to the Hive table, the configuration operation is a selection operation for selecting the database corresponding to the Hive table. When the configuration item is used to represent a name of the Hive table, the configuration operation is an input operation for inputting the name of the Hive table.

For example, the trigger operation for the generation control may be a single-click operation or a double-click operation. As another example, the generation control may be a control that can accept voice information. Correspondingly, the trigger operation for the generation control may be instruction information for generating the metadata. The user may implement voice input through the generation control, thereby implementing the trigger operation for the generation control. For example, the user may say “I want to generate metadata of the Hive table” or “I want to generate a Chinese name of the Hive table”, and the like. Based on the voice input, the input voice is recognized. When the input voice is recognized as an instruction for generating metadata, it is determined that the user performs the trigger operation for the generation control in the data generation page.

For example, in the data generation page, a generation control for generating all metadata associated with the data table may be included. It may be understood that the trigger operation for the generation control is used to generate all metadata associated with the data table. As another example, each piece of metadata corresponds to one generation control. It can be understood that the trigger operation for the generation control is only used to generate the metadata corresponding to the generation control.

For example, the user information of the user may be a user identification and business line information to which the user belongs, and the like. It should be noted that the user information of the user may be obtained in advance and stored in the electronic device, and the corresponding user information is directly called when the metadata is generated.

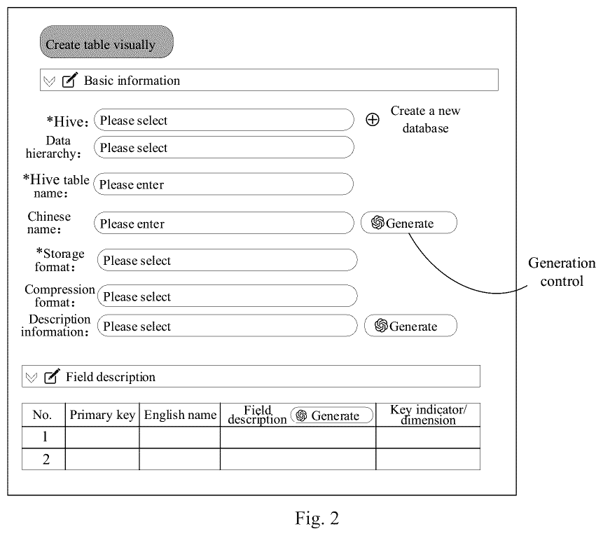

FIG. 2 is a schematic diagram of a data generation page according to an exemplary embodiment of the present disclosure. With reference to FIG. 2, the configuration item in the data generation page includes a configuration item “*Hive” for selecting a database, a configuration item “*Hive table name” for inputting a Hive table name, a configuration item “*Storage format” for identifying a storage format of the Hive table, a configuration item “Compression format” for identifying a compression format of the Hive table, and the like. In these configuration items, the configuration item carrying the “*” sign is a necessary configuration item, for example, “*Hive” and “*Hive table name” are necessary configuration items. Correspondingly, the configuration item not carrying the “*” sign is a non-necessary configuration item, for example, “Compression format” is the non-necessary configuration item. In FIG. 2, the configuration item marked with the generation control is a configuration item for which the metadata can be automatically filled, such as the “Chinese name”, “Field description”, and “Description information” in FIG. 2. Based on FIG. 2, the corresponding metadata may be generated in response to the trigger operation for the generation control in the data generation page.

The metadata of the data table may be generated based on the constraint condition by using a pre-trained prediction model. For the prediction model, reference may be made to the related embodiments described below.

Through the above method, based on the data generation page of the data table, the user may perform the configuration operation for the configuration item of the data table in the data generation page, so that the metadata is automatically generated based on the the configuration information and the user information corresponding to the user who performs the configuration operation, and the metadata is displayed in the display region for displaying the metadata, to implement automatic filling of the metadata in the data table, without the need for the user to add the metadata manually, and the user information is considered when the metadata is generated, so that personalized requirements of the user for the metadata can be met, thereby improving the accuracy of the metadata, which is beneficial to improving the quality and efficiency of data management.

In a possible way, the step of displaying the metadata in the display region for displaying the metadata in the data generation page may be implemented in the following way: displaying a first assembly in the data generation page, in which the first assembly includes a confirmation filling control; and in response to a trigger operation for the confirmation filling control, displaying the metadata in the display region for displaying the metadata in the data generation page.

The trigger operation for the confirmation filling control may be a single-click operation or a double-click operation.

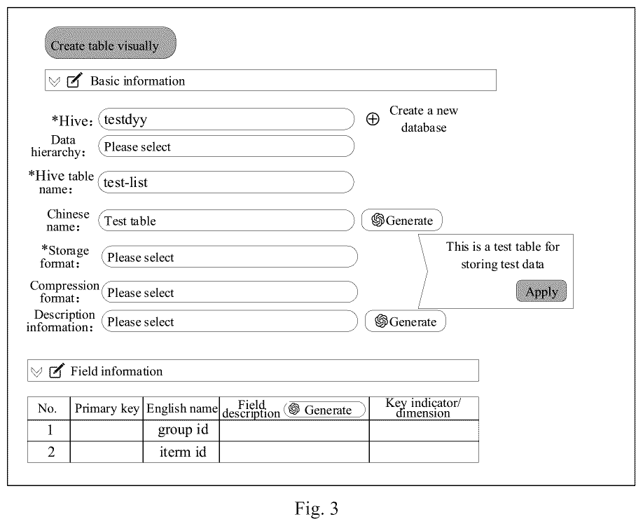

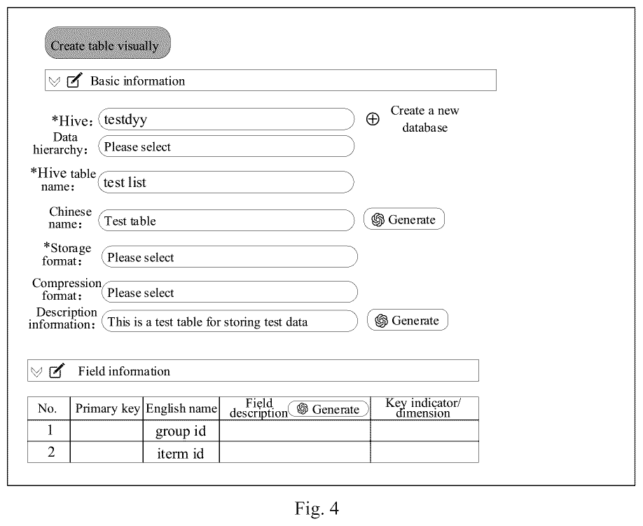

For example, while the confirmation filling control is displayed, the metadata may be displayed by using the first assembly. That is, after the metadata is generated, whether to apply the metadata may be displayed by using the first assembly. Both the confirmation filling control and the displayed metadata are used to prompt the user to apply the metadata. FIG. 3 is another schematic diagram of a data generation page according to an exemplary embodiment of the present disclosure. In FIG. 3, “This is a test table for storing test data” is the generated metadata. The “Apply” shown in FIG. 3 is used as the confirmation filling control. By clicking the “Apply”, “This is a test table for storing test data” may be filled into the display region for displaying the metadata. As an example, please refer to the data generation page shown in FIG. 4.

Through the above method, the metadata is filled after the user's authorization to apply the metadata is obtained, so that the filled metadata meets the user requirements of the user.

In a possible way, the first assembly may further include a re-generation control, and the data generation method may further include the following step: in response to a trigger operation for the re-generation control, regenerating metadata of the data table based on the constraint condition.

The trigger operation for the re-generation control may be a single-click operation or a double-click operation.

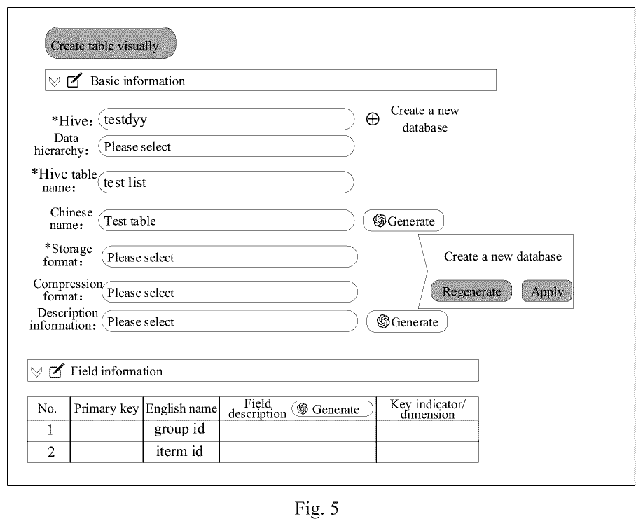

FIG. 5 is another schematic diagram of a data generation page according to an exemplary embodiment of the present disclosure. With reference to FIG. 5, the first assembly includes a re-generation control “Regenerate”. The metadata of the data table is regenerated based on the constraint condition in response to a trigger operation for the re-generation control “Regenerate”.

For example, a prediction model for regenerating the metadata of the data table may be different from a prediction model for generating the previous metadata, so that different metadata can be generated for the user to apply.

Through the above method, when receiving feedback indicating that the user is not satisfied with the generated metadata, new metadata may be regenerated, thereby meeting the diversified metadata requirements of the user.

In a possible way, the above data generation method may further include the following step: displaying progress prompt information in the data generation page, in which the progress prompt information is used to indicate a generation progress of the metadata.

For example, the progress prompt information may be information showing the generation progress in the form of a progress bar or a circular diagram.

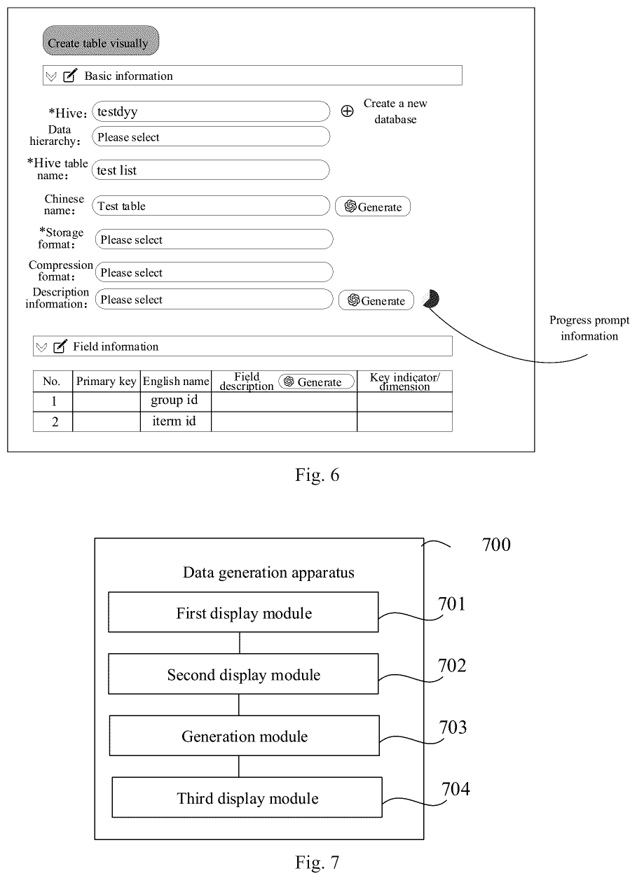

FIG. 6 is another schematic diagram of a data generation page according to an exemplary embodiment of the present disclosure. With reference to the progress prompt information shown in FIG. 6, the user can learn the generation progress of the metadata by viewing the progress prompt information shown in FIG. 6.

In this way, the user can view real-time feedback of the generation progress in the data generation page, so as to learn the working status of the prediction model at any time.

It can be seen from the above content that the metadata of the data table may be generated based on the constraint condition by using the pre-trained prediction model. In a possible way, the prediction model may be trained by: obtaining a sample set, in which the sample set includes historical metadata, historical configuration information, and historical user information that are entered by different users when the data table is historically constructed; and obtaining a prediction model for generating metadata based on the sample set.

The historical metadata, the historical configuration information, and the historical user information may be correspondingly referred to the configuration information, the metadata, and the user information in the related embodiments described above, details are not described in this embodiment.

For example, the prediction model may be a multi-layer perceptron.

Through the above method, the sample set is constructed by using the historical metadata, the historical configuration information, and the historical user information that are entered historically when the data table is constructed historically, so that the prediction model for generating the metadata preferred by different users is obtained through training.

In a possible way, the above data generation method may further include the following step: in response to the trigger operation for the re-generation control, constructing first sample data based on the metadata of the data table that is generated based on the constraint condition and the constraint condition, in which the first sample data is used to update the pre-trained prediction model.

It can be learned from the above content that the prediction model is used to generate the metadata of the data table based on the constraint condition.

It can be understood that when the user performs the trigger operation for the re-generation control, it may indicate that the user is not satisfied with the currently generated metadata. Therefore, in this case, the currently generated metadata and the constraint condition for generating the currently metadata may be collected as the first sample data for updating the pre-trained prediction model. Therefore, through the real-time feedback of the user on the generated metadata and the dynamic learning mechanism, full-link management of the metadata generation process and the metadata generation result can be implemented, and the management capability of the overall data assets is improved. Moreover, the prediction model is updated based on the dynamic learning mechanism, so that the prediction model can be continuously optimized, and the metadata predicted based on the optimized prediction model can meet the user requirements of the user.

In a possible way, the above data generation method may further include the following step: in response to an edit operation for the metadata, obtaining modified metadata; and constructing second sample data based on the modified metadata and the constraint condition, in which the second sample data is used to update the pre-trained prediction model.

It can be learned from the above content that the prediction model is used to generate the metadata of the data table based on the constraint condition.

It can be understood that when the user performs the edit operation for the metadata, it may indicate that the user is not satisfied with the currently generated metadata. Therefore, in this case, the currently modified metadata and the constraint condition for generating the currently metadata may be collected as the second sample data for updating the pre-trained prediction model. Therefore, through the real-time feedback of the user on the generated metadata and the dynamic learning mechanism, full-link management of the metadata generation process and the metadata generation result can be implemented, and the management capability of the overall data assets is improved. Moreover, the prediction model is updated based on the dynamic learning mechanism, so that the prediction model can be continuously optimized, and the metadata predicted based on the optimized prediction model can meet the user requirements of the user.

In a possible way, the training or updating the prediction model based on the dynamic learning mechanism may include adjusting a weight of the configuration information and the user information corresponding to the user on the generated metadata, to implement the training or updating of the prediction model; the training or updating the prediction model based on the dynamic learning mechanism may include adjusting model parameters such as a gradient and a learning rate, to implement the training or updating of the prediction model; the training the prediction model based on the dynamic learning mechanism may include implementing the training of the prediction model by using the historical metadata entry of the user; and the updating the prediction model based on the dynamic learning mechanism may include updating the prediction model based on the user's feedback on the generated metadata, to implement the updating of the prediction model.

Based on the same concept, the embodiments of the present disclosure provide a data generation apparatus. FIG. 7 is a block diagram of a data generation apparatus according to an exemplary embodiment of the present disclosure. With reference to FIG. 7, the data generation apparatus 700 includes:
a first display module 701, configured to display a data generation page of a data table;
a second display module 702, configured to, in response to a configuration operation for a configuration item of the data table in the data generation page, display configuration information corresponding to the configuration item;
a generation module 703, configured to, in response to a trigger operation for a generation control in the data generation page, generate metadata of the data table based on a constraint condition, in which the constraint condition comprises the configuration information and user information corresponding to a user who performs the configuration operation; and
a third display module 704, configured to display the metadata in a display region for displaying the metadata in the data generation page.

In a possible way, the third display module 704 includes:
a first display sub-module, configured to display a first assembly in the data generation page, in which the first assembly comprises a confirmation filling control; and
a second display sub-module, configured to, in response to a trigger operation for the confirmation filling control, display the metadata in the display region for displaying the metadata in the data generation page.

In a possible way, the first assembly further comprises a re-generation control, and the data generation apparatus 700 further includes:
a re-generation module, configured to, in response to a trigger operation for the re-generation control, regenerate the metadata of the data table based on the constraint condition.

In a possible way, the data generation apparatus 700 further includes:
a first construction module, configured to, in response to the trigger operation for the re-generation control, construct first sample data based on the metadata of the data table that is generated based on the constraint condition and the constraint condition, in which the first sample data is used to update a pre-trained prediction model, and the prediction model is used to generate the metadata of the data table based on the constraint condition.

In a possible way, the data generation apparatus 700 further includes:
an obtaining module, configured to obtain modified metadata in response to an edit operation for the metadata; and
a second construction module, configured to construct second sample data based on the modified metadata and the constraint condition, in which the second sample data is used to update a pre-trained prediction model, and the prediction model is used to generate the metadata of the data table based on the constraint condition.

In a possible way, the metadata of the data table is generated based on the constraint condition by using a pre-trained prediction model, and the prediction model is trained by:
obtaining a sample set, in which the sample set comprises historical metadata, historical configuration information, and historical user information that are entered by different users when the data table is historically constructed; and
obtaining a prediction model for generating metadata based on the sample set.

In a possible way, the data generation apparatus 700 further includes:
a fourth display module, configured to display progress prompt information in the data generation page, in which the progress prompt information is used to indicate a generation progress of the metadata.

The implementation methods of the modules in the data generation apparatus 700 may be referred to the related embodiments described above, and details are not described in this embodiment.

Based on the same concept, the embodiments of the present disclosure provide a computer-readable medium having a computer program stored thereon, when the program is executed by a processing apparatus, the steps of the above data generation method are implemented.

Based on the same concept, the embodiments of the present disclosure provide an electronic device, which includes:
a storage apparatus having a computer program stored thereon; and
a processing apparatus configured to execute the computer program in the storage apparatus, to implement the steps of the above data generation method.

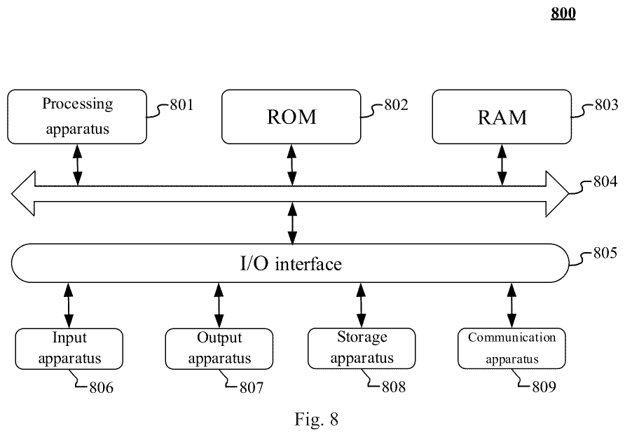

Referring to FIG. 8, which illustrates a structural schematic diagram of an electronic device 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 8 is merely an example, and should not pose any limitation to the functions and the range of use of the embodiments of the present disclosure.

As illustrated in FIG. 8, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 8 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: display a data generation page of a data table; in response to a configuration operation for a configuration item of the data table in the data generation page, display configuration information corresponding to the configuration item; in response to a trigger operation for a generation control in the data generation page, generate metadata of the data table based on a constraint condition, in which the constraint condition comprises the configuration information and user information corresponding to a user who performs the configuration operation; and display the metadata in a display region for displaying the metadata in the data generation page.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. Specific manners of operations performed by the modules in the apparatus in the above embodiment have been described in detail in the embodiments regarding the method, which will not be explained and described in detail herein again.

1. A data generation method, comprising:
displaying a data generation page of a data table;
in response to a configuration operation for a configuration item of the data table in the data generation page, displaying configuration information corresponding to the configuration item;
in response to a trigger operation for a generation control in the data generation page, generating metadata of the data table based on a constraint condition, wherein the constraint condition comprises the configuration information and user information corresponding to a user who performs the configuration operation; and
displaying the metadata in a display region for displaying the metadata in the data generation page.

2. The method according to claim 1, wherein the displaying the metadata in a display region for displaying the metadata in the data generation page comprises:
displaying a first assembly in the data generation page, wherein the first assembly comprises a confirmation filling control; and
in response to a trigger operation for the confirmation filling control, displaying the metadata in the display region for displaying the metadata in the data generation page.

3. The method according to claim 2, wherein the first assembly further comprises a re-generation control, and the method further comprises:
in response to a trigger operation for the re-generation control, regenerating metadata of the data table based on the constraint condition.

4. The method according to claim 3, wherein the method further comprises:
in response to the trigger operation for the re-generation control, constructing first sample data based on the metadata of the data table generated based on the constraint condition and the constraint condition, wherein the first sample data is used to update a pre-trained prediction model, and the prediction model is used to generate the metadata of the data table based on the constraint condition.

5. The method according to claim 1, wherein the method further comprises:
in response to an edit operation for the metadata, obtaining modified metadata; and
constructing second sample data based on the modified metadata and the constraint condition, wherein the second sample data is used to update a pre-trained prediction model, and the prediction model is used to generate the metadata of the data table based on the constraint condition.

6. The method according to claim 1, wherein the metadata of the data table is generated based on the constraint condition by using a pre-trained prediction model, and the prediction model is trained by:
obtaining a sample set, wherein the sample set comprises historical metadata, historical configuration information, and historical user information that are entered by different users when the data table is historically constructed; and
obtaining a prediction model for generating metadata based on the sample set.

7. The method according to claim 1, wherein the method further comprises:
displaying progress prompt information in the data generation page, wherein the progress prompt information is used to indicate a generation progress of the metadata.

8. A non-transitory computer-readable medium having a computer program stored thereon, wherein when the program is executed by a processing apparatus, steps of a data generation method are implemented, the method comprises:
displaying a data generation page of a data table;
in response to a configuration operation for a configuration item of the data table in the data generation page, displaying configuration information corresponding to the configuration item;
in response to a trigger operation for a generation control in the data generation page, generating metadata of the data table based on a constraint condition, wherein the constraint condition comprises the configuration information and user information corresponding to a user who performs the configuration operation; and
displaying the metadata in a display region for displaying the metadata in the data generation page.

9. An electronic device, comprising:
a storage apparatus having a computer program stored thereon; and
a processing apparatus configured to execute the computer program in the storage apparatus to:
display a data generation page of a data table;
in response to a configuration operation for a configuration item of the data table in the data generation page, display configuration information corresponding to the configuration item;
in response to a trigger operation for a generation control in the data generation page, generate metadata of the data table based on a constraint condition, wherein the constraint condition comprises the configuration information and user information corresponding to a user who performs the configuration operation; and
display the metadata in a display region for displaying the metadata in the data generation page.

10. The electronic device according to claim 9, wherein the processing apparatus configured to display the metadata in a display region for displaying the metadata in the data generation page is configured to:
display a first assembly in the data generation page, wherein the first assembly comprises a confirmation filling control; and
in response to a trigger operation for the confirmation filling control, display the metadata in the display region for displaying the metadata in the data generation page.

11. The electronic device according to claim 10, wherein the first assembly further comprises a re-generation control, and the processing apparatus is further configured to:
in response to a trigger operation for the re-generation control, regenerate metadata of the data table based on the constraint condition.

12. The electronic device according to claim 11, wherein the processing apparatus is further configured to:
in response to the trigger operation for the re-generation control, construct first sample data based on the metadata of the data table generated based on the constraint condition and the constraint condition, wherein the first sample data is used to update a pre-trained prediction model, and the prediction model is used to generate the metadata of the data table based on the constraint condition.

13. The electronic device according to claim 9, wherein the processing apparatus is further configured to:
in response to an edit operation for the metadata, obtain modified metadata; and
construct second sample data based on the modified metadata and the constraint condition, wherein the second sample data is used to update a pre-trained prediction model, and the prediction model is used to generate the metadata of the data table based on the constraint condition.

14. The electronic device according to claim 9, wherein the metadata of the data table is generated based on the constraint condition by using a pre-trained prediction model, and the prediction model is trained by:
obtaining a sample set, wherein the sample set comprises historical metadata, historical configuration information, and historical user information that are entered by different users when the data table is historically constructed; and
obtaining a prediction model for generating metadata based on the sample set.

15. The electronic device according to claim 9, wherein the processing apparatus is further configured to:
display progress prompt information in the data generation page, wherein the progress prompt information is used to indicate a generation progress of the metadata.
